(19) United States
(12) Patent Application Publication
(10) Pub. No.: US 2006/0169110 A1
(43) Pub. Date: Aug. 3, 2006

(54) Test piece splitting device

(76) Inventors: Chiao-Chung Huang, Dashi Jen (TW); Kuo-Kang Yeh, Yangmei Jen (TW); Ming-Hann Tsai, Taipei (TW); Po-Tsun Chen, Hsinchu (TW); Kuo-Ming Huang, Taiping City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/667,124

(22) Filed: Sep. 18, 2003

(30) Foreign Application Priority Data
Sep. 25, 2002 (CN) 91121995

(51) Int. Cl. B26D 1/00; B26D 7/02

(52) U.S. Cl. 83/13; 83/455

(57) ABSTRACT

An apparatus for splitting a test piece. The apparatus includes a base, two pillars and a sliding piece. The base has a centerline. The pillars are disposed on the base. The connection line between the pillars is perpendicular to and divided equally by the centerline. The sliding piece disposed on the base has two fingers parallel to the centerline, and the connection line between the tips of the fingers is perpendicular to and divided equally by the centerline. When splitting a test piece, the sliding piece is pushed to split the test piece along the slits by the fingers and the pillars.

### BACKGROUND OF THE INVENTION

1. Field of the Invention

The present invention relates to a test piece splitting tool, and in particular to a splitting tool with equal levers.

2. Description of the Related Art

Semiconductor substrates are usually damaged by the particles in the air, the failures of the fabrication apparatuses or the man-made faults during the Semiconductor processes. In order to increase the yield and reduce the cost, the cross-sections of the defective substrates are usually scanned and analyzed to find out the problems in processes.

Silicon substrates or glass substrates with defects are cut into small rectangular test pieces. FIG. 1A shows a test piece 10 having a working surface 11 with a target point P, or a defect, where needs to do the cross-section analysis. Two slits 111a, 111b are formed on the working surface 11 aligned with the target point P. The slits 111a, 111b are perpendicular to the long edges of the test piece 10, and separated from the target point P by 10˜100 μm, avoiding damaging the microstructure near the target point P.

The test piece can be simply split by hands. However, the cross-section 12 is usually ragged as shown in FIG. 1B or does not pass through the target point, such that this cross-section 12 cannot be used in the following analysis. Hence, there is a need for a simple and precise test piece splitting tool for the cross-section analysis.

### SUMMARY OF THE INVENTION

An object of the invention is to provide a simple and effective splitting apparatus of semiconductor test pieces. Engineers can use this apparatus to split test pieces. The splitting apparatus of the invention can ensure that each received cross-section is neat and just passes through the target point P.

Accordingly, the present invention provides an apparatus to split a test piece. The apparatus includes a base, two pillars and a sliding piece. The base has a centerline. The pillars are disposed on the base. The connection line between the pillars is perpendicular to and divided equally by the centerline. The sliding piece disposed on the base has two fingers parallel to the centerline, and the connection line between the tips of the fingers is perpendicular to and divided equally by the centerline. When splitting a test piece, the sliding piece is pushed to split the test piece along the slits by the fingers and the pillars.

The present invention also provides an operating method for the splitting device. The method includes the step of providing a test piece having a surface with a target point, of which the structure needs to be analyzed. Next, two slits separated apart on the surface are formed. The slits are aligned with the target point in a predetermined line. Further, the test piece is secured on the base with the surface contacting the pillars, the slits aligned with the centerline of the base. Finally, the sliding piece is moved, such that the fingers contacts the test piece, and pushed forward to split the test piece along the predetermined line.

According to the preferred embodiment, the base has two pivot points at the both sides of the centerline to install the pillars. The pivot points are separated by the first interval, which is divided equally by the centerline. The base has a straight groove along the centerline. The sliding piece has a protrusion movable in the groove along the centerline.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic view of a test piece;

FIG. 1B is a schematic view of a split test piece with a ragged cross-section;

FIG. 2A is an exploded view of the splitting device according to the present invention; and

FIG. 2B shows the test piece disposed on the splitting device according to the present invention.

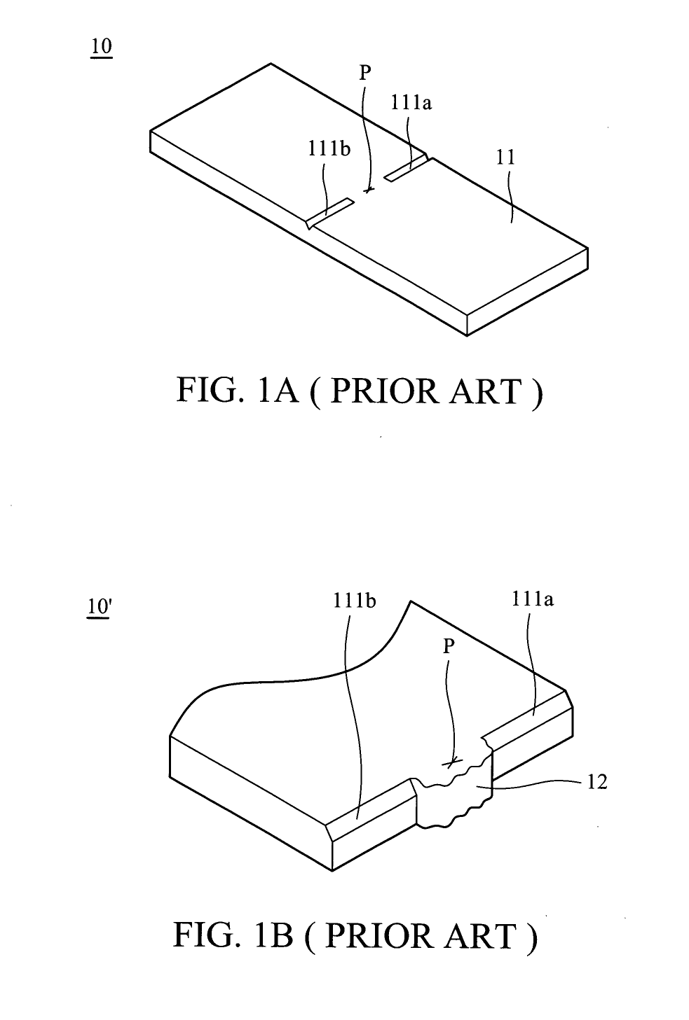

### DETAILED DESCRIPTION OF THE INVENTION

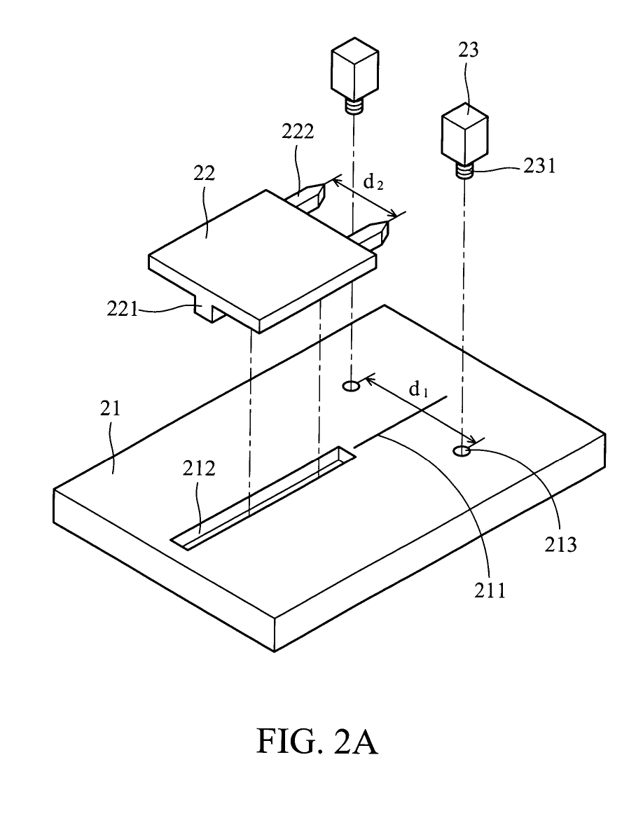

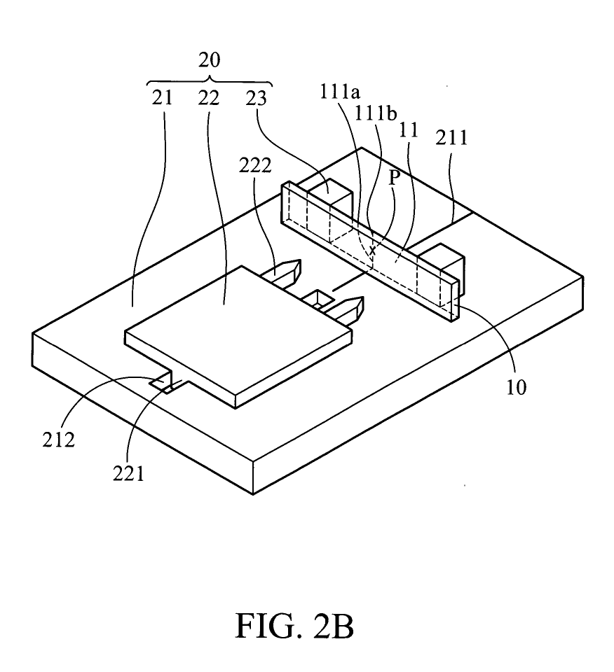

FIG. 2A is an exploded view of the splitting device of the invention. In FIG. 2A, splitting device 20 includes a base 21, two pillars 23 and a sliding piece 22 movably disposed on the base 21.

The base 21 is a metal seat has a centerline 211 and a straight groove 212 parallel to the direction of the centerline 211. The base 21 further has two pivot points 213 at the both sides of the centerline 211 to install the pillars 23. The pivot points 213 are separated by the first interval d₁, which is divided equally by the centerline 211.

The pillars 23 are rectangular solids. Each of the pillars 23 has a thread portion 231 to secure the pillars 23 in the pivot points 213 of the base 21, such that the distance d₁ between two pillars 23 is divided equally by the centerline 211. Moreover, the connection line of the pillars 23 is perpendicular to the centerline 211.

The sliding piece 22 is a metal plate having a protrusion 221 parallel to the centerline 211 on the bottom surface. The width of the protrusion 221 matches the width of the groove 212 on the base 21, such that the sliding piece 21 can be moved in the groove 212 along the direction of the centerline 211. Moreover, at the side surface of the sliding piece 22 are two fingers 222 parallel to the centerline. The connection line between the tips of the fingers 222 is perpendicular to and divided equally by the centerline 211. The second interval d₂ between the tips of two fingers is smaller than the first interval d₁ between the pillars 23.

FIG. 2B shows the test piece disposed on the splitting device of the invention. In FIG. 2B, when splitting a test piece 10, silicon substrates or glass substrates with defects are cut into small rectangular test pieces. The test piece 10 having a working surface 11 with a target point P, or a defect, where needs to do the cross-section analysis. Two slits 111a, 111b are formed on the working surface 11 aligned with the target point P separated from the target point P by 10˜100 μm, avoiding damaging the microstructure near the target point P. The test piece is secured on the base with the working surface contacting the pillars 23, the slits 111a, 111b aligned with the centerline 211 of the base 21. The sliding piece 22 is moved, such that the fingers 222 contact the test piece 10, or with a small distance about several mm. Finally, the sliding piece 22 is pushed forward to split the test piece 10 along the predetermined line of the slits 111a, 111b by the fingers 222 and the pillars 23.

The splitting device of the invention provides a simple and effective splitting method for semiconductor test pieces. The levels of the both side of the test piece are equal, such that the stress of the both side is equal. The splitting apparatus of the invention can ensure that each received cross-section is neat and just passes through the target point P. The cross-section analysis can be done easily.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for splitting a test piece, comprising:
a base with a centerline;
two pillars disposed on the base separated by a first interval to support the test piece, wherein the connection line between the pillars is perpendicular to and divided equally by the centerline; and
a sliding piece disposed on the base movable along the centerline, wherein the sliding piece has two fingers parallel to the centerline separated by a second interval, which is smaller than the first interval, and the connection line between the tips of the fingers is perpendicular to and divided equally by the centerline.

2. The apparatus as claimed in claim 1, wherein the base has two pivot points at the both sides of the centerline to install the pillars.

3. The apparatus as claimed in claim 2, wherein the pivot points are separated by the first interval, which is divided equally by the centerline.

4. The apparatus as claimed in claim 1, wherein the base has a straight groove along the centerline, and the sliding piece has a protrusion movable in the groove along the centerline.

5. An operating method for the apparatus as claimed in claim 1, comprising the step of:
providing a test piece having a working surface with a target point;
forming two slits separated apart on the working surface and aligned with the target point in a predetermined line;
fixing the test piece on the base with the working surface contacting the pillars and the slits aligned with the centerline of the base;
moving the sliding piece, such that the fingers contacts the test piece; and
pushing the sliding piece to split the test piece along the predetermined line by the fingers of the sliding piece and the pillars.
